(19) United States
(12) Patent Application Publication
(10) Pub. No.: US 2003/0012246 A1
(43) Pub. Date: Jan. 16, 2003

(54) Semiconductor zigzag laser and optical amplifier

(76) Inventors: Daniel E. Klimek, Lexington, MA (US); Alexander E. Mandl, Brookline, MA (US)

Correspondence Address: Gregory M. McCloskey, Textron Systems Corporation, 201 Lowell Street, Wilmington, MA, 01887, US

(21) Appl. No.: 10/194,140

(22) Filed: Jul. 12, 2002

Related U.S. Application Data
(60) Provisional application No. 60/304,972, filed on Jul. 12, 2001.

(51) Int. Cl. H01S 3/091; H01S 3/092; H01S 3/081; H01S 3/00

(52) U.S. Cl. 372/70; 359/345; 359/346; 372/93

(57) ABSTRACT

A semiconductor structure includes a first cladding layer, a second cladding layer, and one or more semiconductor active regions. An optical resonator is formed by the inclusion of a first mirror and a second mirror at opposite ends of the structure with respect to the optical axis. One or more angled facets provide the semiconductor structure with optical coupling. The associated beam path along an optical axis within the structure is a zigzag path, which is substantially independent of the height of the active region. A signal generator and an optical amplifier may be formed with the structure. An optical modulator, multiplexer, and demultiplexer may also use the structure.

Priority is claimed for this application under 35 U.S.C. §119 to U.S. provisional Patent Application Serial No. 60/304,972, filed Jul. 12, 2001, the contents of which are incorporated herein by reference.

### BACKGROUND

1. Field of the Invention

The present invention relates to the field of semiconductor lasers. More particularly, an embodiment of the present invention relates to semiconductor lasers wherein an associated beam path travels in a zigzag fashion relative to a longitudinal axis of an active region or active regions of a semiconductor laser.

2. Description of Related Art

Conventional semiconductor lasers, commonly referred to as diode lasers, are divided into two general classes, edge-emitting lasers and vertical-cavity surface-emitting lasers (“VCSEL”s). There are advantages and disadvantages associated with each class.

Edge-emitting semiconductor lasers emit light directly from the edge or exposed surface of a region that includes an optically active medium, forming a gain region, within an optical cavity of a laser. Light emitted from an edge-emitting laser has a frequency spectrum controlled by a gain spectrum of the active medium and restricted to wavelengths where integral multiples of one-half the wavelength are equal to the optical length of the longitudinal cavity axis. The light emitted from an edge-emitting semiconductor laser is characterized by a far-field angular divergence, i.e., the angle at which an output beam produced by the laser spreads at distances from the laser that is relatively large with respect to the dimensions of the output aperture of the laser. The far-field angular divergence for an edge-emitting laser is larger than that of most other lasers. Moreover, the aspect ratio, i.e., the ratio of the far-field angular divergence perpendicular to the depth of the active region to that of the width of the active region, is greater than one. Equivalently stated, the cone of light emitted by the edge-emitting laser is elliptical with a high degree of eccentricity, such that the light produced has a highly asymmetric elliptical distribution. This can make both collimation and coupling to optical fibers difficult. For wavelength control, edge-emitting lasers typically employ costly feedback structures such as distributed feedback structures (DFBs) or distributed Bragg reflectors (DBRs). Edge-emitting lasers generally have the advantages of presenting a long gain length and consequently high power at wavelengths well suited for fiber-optic systems, including those using 1.3 and 1.55 micron (μm) wavelength signals.

VCSELs, in contrast, emit light from a face or surface that is parallel to a region that includes an optically active medium, forming a gain region or layer of the optical resonator of the laser. Light emitted from a VCSEL has a frequency spectrum composed of those frequencies of light controlled by a gain spectrum of the active medium of the VCSEL and the resonator properties of the multilayer coating structures above and below the gain layer. As a result, VCSELs typically have the advantages of presenting an output beam with a large cross-sectional area having a good aspect ratio, i.e., nearly equal to one. With this aspect ratio being near unity, the typical VCSEL output beam is easily collimated and provides facile coupling to optical fibers. Generally, VCSELs have disadvantages that include a short gain length, the necessity of incorporating high reflectivity reflectors, and the difficulty of making such reflectors operate at wavelengths well suited for long-distance fiber-optic systems.

Slab lasers employing a solid state, or alternatively a liquid dye, active medium are known in the art. Certain slab lasers employ a folded-cavity design and are known as “zigzag” lasers due to the path of the light traveling within the slab. The motivation for the design of such zigzag lasers has been the averaging of aberrations produced by thermal and material nonuniformities of the resonator and active medium. Examples of such zigzag lasers are disclosed in Kelin (U.S. Pat. No. 4,617,669; issued 1986), Kuba et al. (U.S. Pat. No. 5,557,628; issued 1996), Komine (U.S. Pat. No. 5,640,480; issued 1997), and Injeyan (U.S. Pat. No. 6,094,297; issued 2000). See also Klimek et al., Dye Laser Studies Using Zig-Zag Optical Cavity, 30 IEEE J. QUANTUM ELECTRONICS 1459 (1994); Alexander Mandl and Daniel Klimek, Single-Mode Operation of a Zig-Zag Dye Laser, 31 IEEE J. QUANTUM ELECTRONICS 916 (1995); and, Alexander Mandl and Daniel Klimek, Chirp Control of a Single-Mode, Good Beam Quality, Zigzag Dye Laser, 33 IEEE J. QUANTUM ELECTRONICS 303 (1997). Beam quality of such zigzag lasers is limited by aberrations arising from nonuniformities of the materials in the resonator.

What is needed, therefore, is a semiconductor laser or semiconductor optical amplifier that can be made by conventional semiconductor fabrication techniques and that provides a long gain length, a good aspect ratio and that does not require expensive feedback structures.

### SUMMARY

Briefly, and in general terms, the present invention includes one or more semiconductor active regions disposed within a zigzag structure. The zigzag structure is transparent to light of the desired frequency or frequencies. Light travels within the zigzag structure along an optical axis that takes a zigzag path with respect to the active region or active regions. Due to total internal reflection (“TIR”), all of the light traveling the zigzag path within the zigzag structure is retained and light is lost or escapes by means of windows or apertures that are at angles less than the TIR angle. Mirrors may be placed at ends of the optical axis, such that the gain region of the zigzag structure is encompassed between the mirrors such that a resonator is formed and the zigzag structure functions as a laser.

The present invention presents multiple aspects. One aspect of the present invention includes an optical amplifier in which an optical signal to be amplified enters a zigzag structure along a zigzag optical axis, is amplified in one or more active regions within the zigzag structure, and then exits the zigzag structure along the optical axis. Other aspects of the present invention include a zigzag structure having mirrors at opposing ends of the optical axis and thereby forming a resonator or laser. The laser may operate as a light source or “signal generator” that with or without an input optical beam may generate an output beam. The output beam can in turn be modulated by any of a number of optical signal modulators.

A first aspect of the present invention includes an optical amplifier including a zigzag structure having a zigzag optical axis. The zigzag structure includes a first active region.

Light travels along the zigzag optical axis and takes a zigzag path with respect to the first active region. The zigzag structure is in optical communication with a first facet and a second facet, both crossing the zigzag optical axis. The zigzag structure includes a first cladding layer and a second cladding layer. The first active region is between the first cladding layer and the second cladding layer. A means for pumping may be included, which provides a population inversion in the first active region. The means for pumping may be a current source connected to the gain region. The means for pumping may also be an optical signal source. The first and second cladding layers may each have an index of refraction greater than the regions immediately exterior to the zigzag structure. An input signal travels in a zigzag path within the zigzag structure and is amplified by the first active region.

A second aspect includes a semiconductor zigzag laser. The laser includes a zigzag structure having a zigzag optical axis. The zigzag structure includes a first active region. Light travels along the zigzag optical axis and takes a zigzag path with respect to the first active region. The zigzag structure is in optical communication with a first facet and a second facet, both crossing the zigzag optical axis. A first mirror and a second mirror are positioned at opposite ends of the optical axis adjacent the first facet and second facet, respectively, with the zigzag structure positioned between the first and the second mirrors with respect to the optical axis, forming a resonator. The first and second mirror are parallel to one another with respect to the zigzag optical axis, and they each have different reflectivities. The zigzag structure includes a first cladding layer and a second cladding layer. The first active region is between the first cladding layer and the second cladding layer. A means for pumping is included, which provides a population inversion in the first active region. The means for pumping may be a current source connected to the gain region. The means for pumping may also be an optical signal source. The first and second cladding layers each have an index of refraction greater than the regions immediately exterior to the zigzag structure. Light resonates within the resonator between the first and second mirrors, and the light escapes the zigzag structure by means of the mirror having the lower reflectivity.

A third aspect includes a method of modulating an optical signal including the steps of generating an optical signal from a semiconductor zigzag laser and modulating the signal with an optical modulator. A non-exclusive list of suitable modulators includes piezoelectric elements, Kerr cells, Pockels cells, and Mach-Zehnder interferometers.

A fourth aspect includes an optical modulation system that includes an optical resonator including a zigzag structure having a zigzag optical axis. The zigzag structure includes a first active region. Light that travels along the zigzag optical axis takes a zigzag path with respect to the first active region. The zigzag structure is in optical communication with a first facet and a second facet, both crossing the zigzag optical axis. The optical resonator also includes a first mirror and a second mirror. Each mirror has a different reflectivity. The first and second mirrors are parallel to one another with respect to the zigzag optical axis. The zigzag structure has a first cladding layer and a second cladding layer, each of which having an index of refraction greater than the region immediately exterior to the zigzag structure. The first active region is between the first cladding layer and the said second cladding layer. Also included is a means for pumping the first active region, with the means for pumping providing a population inversion in the first active region. The means for pumping may be electronic or optical, and may be a current source connected to the optical resonator. A signal modulator is in optical communication with the optical resonator. A modulated optical output signal is produced.

A fifth aspect includes a semiconductor zigzag demultiplexing system for use in a communication system that uses wavelength-division multiplexing. The semiconductor zigzag demultiplexing system includes a zigzag structure having a zigzag optical axis. The zigzag structure further includes a first active region. Light travels along the zigzag optical axis and takes a zigzag path with respect to the first active region. The zigzag structure is in optical communication with a first facet and a second facet crossing the zigzag optical axis. The zigzag structure has a first cladding layer and a second cladding layer, and each has an index of refraction greater than the region immediately exterior to the zigzag structure. The first active region is between the first cladding layer and said second cladding layer. The semiconductor zigzag demultiplexing system further includes a pumping means, examples of which include a current source connected to the gain region, and an optical signal. The means for pumping provides a population inversion in the first semiconductor active region. An input optical fiber is in optical communication with the zigzag structure via the first facet. The optical fiber carries an input signal that includes a plurality of separate carrier signals each of a different frequency. Each separate carrier signal travels in a separate zigzag path within the gain region and is amplified by the first semiconductor active region. A plurality of output optical fibers are in optical communication with the zigzag structure via the second facet. Each separate carrier signal, after it is amplified, enters into a different one of the plurality of output optical fibers.

A sixth aspect includes a semiconductor zigzag multiplexing system for use in a communication system that uses wavelength-division multiplexing. The semiconductor zigzag multiplexing system includes a zigzag structure having a zigzag optical axis. The zigzag structure further includes a first active region. Light travels along the zigzag optical axis and takes a zigzag path with respect to the first active region. The zigzag structure is in optical communication with a first facet and a second facet crossing the zigzag optical axis. The zigzag structure has a first cladding layer and a second cladding layer, and each has an index of refraction greater than a region immediately exterior to the zigzag structure. The first active region between the first cladding layer and the second cladding layer. Further included is a pumping means, examples of which include a current source that is connected to the gain region, or a light signal. The means for pumping provides a population inversion in the first semiconductor active region. A plurality of input optical fibers are in optical communication with the zigzag structure via the first facet. Each of the plurality of optical fibers carries an input carrier signal of a different frequency, and each separate carrier signal travels in a separate zigzag path within the zigzag structure and also is amplified by the first semiconductor active region. An output optical fiber is in optical communication with the zigzag structure via the second facet. Each separate carrier signal, after has been amplified, enters into the output optical fiber.

A seventh aspect includes a semiconductor laser that includes at least one active region between a first cladding layer and a second cladding layer. A first facet and a second facet are in optical communication via a zigzag optical axis. The zigzag optical axis passes through the first cladding layer, the at least one active region, and the second cladding layer. A means for energizing the laser may be included. The means for energizing may be a current source.

### DESCRIPTION OF THE DRAWINGS

The present invention will be more fully understood by reference to the following Detailed Description, accompanied by the Drawings.

FIG. 1 is a side-view and shows a cross-section of an optical amplifier employing prism coupling with an antireflective coating according to one embodiment of the present invention.

FIG. 2 is a side-view and shows a cross-section of an optical amplifier employing prism coupling with an antireflective coating according to one embodiment of the present invention.

FIG. 3 shows a cross section of an optical amplifier with cleaved-facet coupling according to another embodiment of the present invention.

FIG. 4 shows a cross section of a signal generator with a max reflector mirror at one end and a partial reflectivity output coupler at the other end.

FIG. 5 shows a cross section of a signal generator with prism coupling in conjunction with a max reflector mirror, according to an alternate embodiment of the present invention.

FIG. 6 shows a signal generator with a corner cube prism and prism out-coupling according to an alternate embodiment of the present invention.

FIG. 7 shows a system for modulation having a signal generator and a piezoelectric element, which is used to modulate the output of the signal generator according to yet another embodiment of the present invention.

FIG. 8 shows a cooling system for cooling three signal generators according to one embodiment of the present invention.

### DETAILED DESCRIPTION

The following description is provided by way of illustration only and, unless expressly stated otherwise, is not intended to limit the scope of the present invention.

The present invention includes both an optical amplifier and a laser or signal source (“signal generator”). Within the scope of the present invention, the term “optical amplifier” may also include, but is not limited to, a multiplexer and demultiplexer. As used herein, the term “facet” includes reference to a plane segment or portion of a plane through which light may travel. Furthermore, the term “facet” may include reference to a plane segment having any type of perimeter, examples of which include, but are not limited to, parallelograms, quadrilaterals, trapezoids, and combinations of curved lines. The term “facet” may, but does not necessarily, include reference to a crystal facet plane. Referring to the drawings, in which like elements are numbered similarly, a semiconductor zigzag laser 10 or semiconductor optical amplifier 10 of the present invention are shown. Common to the embodiments shown is structure that includes a semiconductor active region 11 disposed between a first cladding layer 12 and a second cladding layer 13 and a first facet and a second facet, which are in optical communication via a zigzag optical axis. This structure may be referred to herein as a “zigzag structure” 18. Light travels through the zigzag structure 18 along an optical axis in a zigzag path due to total internal reflection (“TIR”), crossing the plane of the active region 11, where it is amplified, with an acute angle of incidence, i.e., θ_{c}<θᵢ<90°, where θ_{c} is the arcsine of the ratio of the index of refraction of the zigzag structure 18 and that of the region exterior to it. The zigzag structure 18 is defined by the interfaces or surfaces that contain the light by TIR.

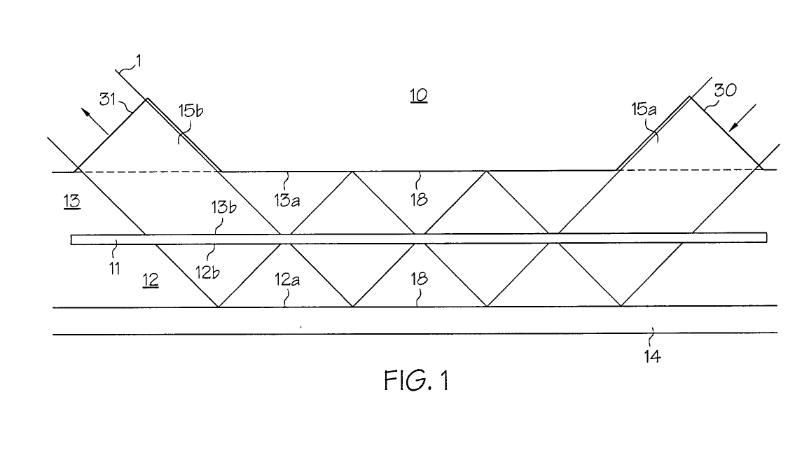

With reference to FIG. 1, an optical amplifier 10 according to an embodiment of the present invention is shown. An active region 11 is shown within a zigzag structure 18 and between a first cladding layer 12 and second cladding layer 13, both of which are transparent to photons of a desired wavelength. The first cladding layer 12 is shown disposed on a substrate 14. The first cladding layer 12 may be made of a material with a sufficiently higher index of refraction than the substrate 14, resulting in TIR at a first interface 12a between the substrate 14 and the first cladding layer 12.

In the embodiment shown in FIG. 1, there is no layer or material disposed on the second cladding layer 13. This results in a second interface 13a between the second cladding layer 13 and air. Because of the difference in the index of refraction of the second cladding layer 13 and that of air, TIR occurs at the second interface 13a. An input prism 15a and an output prism 15b may be placed in contact with the second cladding layer 13 at opposing ends of the optical amplifier 10. The zigzag structure 18 shown in FIG. 1 is defined by interfaces 12a and 13a, and the exterior faces 30, 31, of optical coupling -prisms 15a and 15b. The prisms 15a, 15b cross the zigzag optical axis of the beam traveling within the zigzag structure.

The material for the active region 11 may be any direct-gap semiconductor. The term “direct-gap” refers to the valence-band maximum and the conduction-band minimum corresponding to the same momentum, which can be seen, graphically, on a graph of the energy-momentum relation of the semiconductor. This direct-gap alignment in such materials is demonstrative of the capacity for efficient photon emissions during transitions from the conduction band to the valence band since during such transitions photons are predominantly emitted while few if any phonons are emitted. The material for the remainder of the zigzag structure need only be transparent to one or more desired frequencies and have the capability to be bonded or joined or grown to the semiconductor active region. The first and second cladding layers may be p-doped or n-doped as required by other considerations.

If the material of the active region or active regions is polarization independent, then the indices of refraction of the first and second cladding layer need not be matched to that of the one or more active regions. When the material of the active region or active regions is polarization dependent and requires s-polarization for desired performance, then the indices of refraction of each cladding layer should be closely matched to that of the active region or active regions so that reflections at the cladding/active region interfaces are minimized.

Examples of suitable direct-gap semiconductors for the active region 11 include, but are not limited to, the following: binary semiconductors including Gallium Arsenide (GaAs), Gallium Nitride (GaN), Gallium Lead (GaSb), Indium Phosphide (InP), Indium Arsenide (InAs), and Indium Lead (InSb); ternary semiconductors including Aluminum Gallium Arsenide (AlₓGa₁₋ₓAs), Aluminum Indium Arsenide (AlₓIn₁₋ₓAs), Gallium Indium Arsenide (GaₓIn₁₋ₓAs), Gallium Arsenide Lead (GaAs₁₋ₓSbₓ), and Indium Arsenide Phospide (InAs₁₋ₓPₓ); and quaternary semiconductors including Indium Gallium Arsenide Phosphide (In₁₋ₓGaₓAs_{1-y}P_{y}), Indium Nitride Arsenide Phosphide (InN_{y}AsₓP₁₋ₓ-y), and Aluminum Gallium Indium Arsenide (AlₓGa_{y}In_{1-x-y}As). Where an alloy system can change from being a direct-gap to indirect-gap depending on the proportion of alloy elements, the direct-gap is preferred.

In a preferred embodiment, for dense wavelength-division-multiplexing (DWDM) applications, Indium Gallium Arsenide Phosphide (InGaAsP) may be used for the active region 11 material, which produces photons of wavelengths near 1.55 microns. In other preferred embodiments, alloys of Indium Phosphide (InP) or those of Gallium Arsenide (GaAs) may be used in the active region 11. In certain exemplary embodiments where InGaAs or GaAs are used as material for the active region, fabrication techniques including cleaving and micro polishing, which are discussed in greater detail below, may be used.

The active region 11 includes at least one p-doped direct-gap semiconductor region and at least one n-doped direct-gap semiconductor region (thereby forming a p-n junction or p-i-n junction). While these n-doped and p-doped regions are not shown in the drawings, it should be understood that they are present in the active region 11.

The active region 11 may also include one or more heterostructures or quantum structures, or combinations of such structures, made from suitable direct-gap semiconductors. The term “quantum structures” includes quantum wells, quantum wires, and quantum dots. In exemplary embodiments, quantum wells are present within the active region 11. Certain embodiments of the present invention include quantum wells that are subjected to tensile strain. Certain embodiments include heterostructures, which may include double heterostructures. Preferably, all of the layers of the apparatus of present invention are lattice-matched to their neighbors so that the apparatus may be fabricated by conventional semiconductor fabrication techniques. The term “lattice-matched” means, in the context of crystal structure, that the material of each layer is chosen to have a crystal lattice constant closely matched to that of its neighbor(s). In certain embodiments, however, particularly those having strained quantum wells in the active region 11, a certain amount of lattice mismatch may be desired.

The first cladding layer 12 and the second cladding layer 13 are made of suitable materials(s) so as to be transparent to desired wavelengths. In a preferred embodiment, the first cladding layer 12 is made of undoped InGaP and the second cladding layer 13 is also made of undoped InGaP. In an example of another preferred embodiment, the first cladding layer 12 is made of undoped GaAs and the second cladding layer 13 is also made of undoped GaAs. As shown, for example in FIG. 1, the two cladding layers, 12, 13, each have a distal face to the active region 11, denoted as 12a and 13a, respectively. The two cladding layers consequently each have a proximal face to the active region 11, denoted as 12b and 13b, respectively. In preferred embodiments, electrical contacts (not shown) supply the current necessary for pumping.

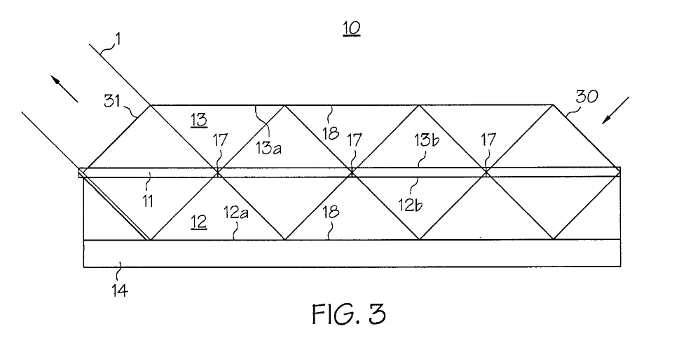

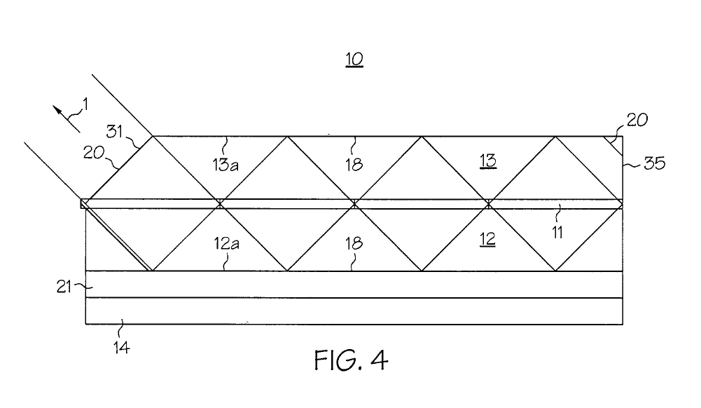

With continued reference to FIG. 1, construction of the semiconductor zigzag optical amplifier 10 will now be described. The lasers 10 shown in FIGS. 4-8 may be constructed in a similar manner. Layers of material are first deposited or grown on a suitable substrate 14. A monolithic structure is then formed by suitable construction techniques. The monolithic structure includes the substrate 14, the active region 11, the first cladding layer 12, the second cladding layer 13, and the index-differential layer 21 (FIG. 4), if present, and the angled facet or facets 30, 31 (FIG. 3). The angled facets may have the shape of a plane segment and may be formed by cleaving, etching, ion milling or other semiconductor process that can remove material from the monolithic structure formed on substrate 14. Suitable fabrication methods include, but are not limited to, metallorganic chemical vapor deposition (MOCVD), Selective Area MOCVD (SA-MOCVD) or by molecular beam epitaxy (MBE). The angled facets 30, 31 (FIG. 3) may also be formed as diffractive optic elements (DOE) through known DOE fabrication techniques. For a general background on DOEs and associated methods of fabrication, see Stefan Sinzinger and Jurgen Jahns, Microoptics, ch. 5 (1999), the contents of which are incorporated herein by reference.

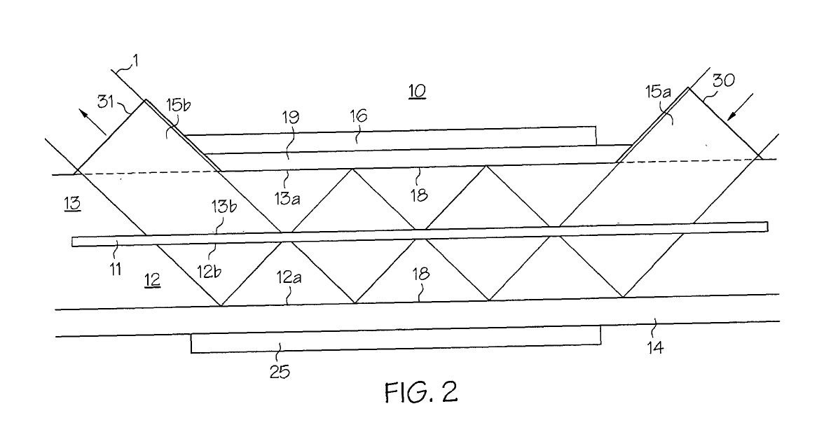

Not shown in the drawings, but used with all of the embodiments depicted are means for exciting the active region 11 that produce a population inversion which creates light amplification by the stimulated emission of radiation. This pumping means is preferably electronic, i.e., a voltage applied to electrical contacts, which supply an electric current through the active region 11. When electronic pumping is employed, appropriate electrical contacts 25, as shown in FIG. 2, may be fabricated onto or connected to the semiconductor zigzag laser 10 by any of a number of known techniques. The bias supplied by the electrical contacts 25 may be direct current or alternating current. Though electronic pumping is preferred, optical pumping of the active region 11 by optical pumping means, e.g., by flash lamp or laser diode, is also within the scope of the present invention.

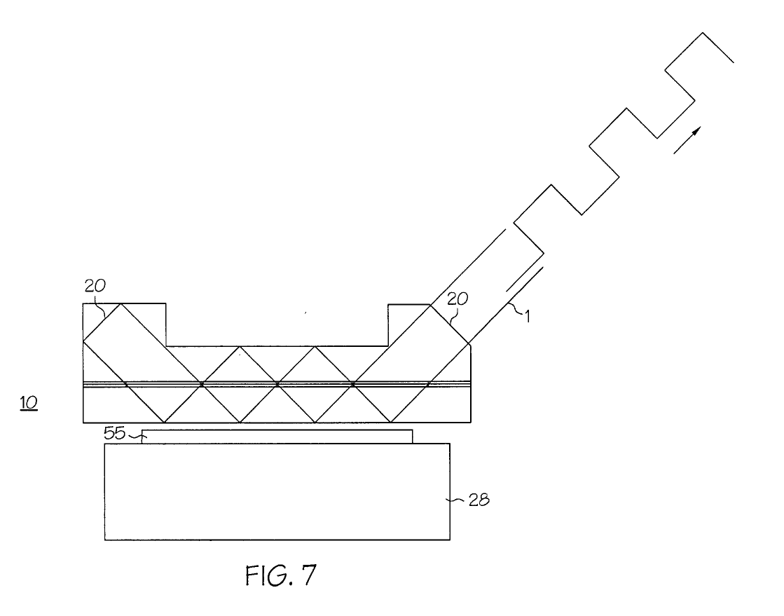

Numerous means for optical coupling of the semiconductor zigzag laser and optical amplifier are within the scope of the present invention, including, but not limited to, prism coupling and evanescent-wave coupling. For evanescent-wave coupling, a first lens, prism, or other waveguide structure, which may include a zigzag structure, (the “first structure”) is placed within a few wavelengths or fractions of wavelengths from a second lens, prism, or other waveguide structure (the “second structure”), thus creating a gap between the two structures. The electromagnetic field within the first structure couples to the second structure and crosses the gap by means of the evanescent field, i.e., evanescent-wave coupling. Evanescent-wave coupling may be used to modulate the output beam 1 of the semiconductor zigzag laser 10, as is shown in FIG. 7 and as is described in more detail below.

With continued reference to FIG. 1, the input prism 15a and the output prism 15b may be coated with an antireflective coating for improved performance. When a prism is used for optical coupling, the material for the prism(s) is chosen to closely match the index of refraction of that of the layer to which it is coupled. When prisms are used for optical coupling, the prisms 15a, 15b are preferably placed in contact with one or both of the cladding layers 12, 13 to minimize loss in the structure 18 that includes the semiconductor active region 11 disposed between the first cladding layer 12 and the second cladding layer 13 and first facet 30 and second facet 31, which are in optical communication via a zigzag optical axis.

In FIG. 2, another embodiment of the optical amplifier 10 is shown. A first electrical contact 25 is formed, through known techniques, in contact with the substrate 14. The active region 11, the first cladding layer 12, the second cladding layer 13, and the substrate 14 are constructed as described above with the embodiment of FIG. 1. However as shown in FIG. 2, a protective layer 19 made of silicon dioxide (SiO₂) may be deposited through known techniques, such as low-temperature MOCVD, on top of the second cladding layer 13. The protective layer 19 prevents damage to the second cladding layer 13, and is preferred in embodiments of the present invention that employ alloy systems that include Indium Phosphide (InP). Any of the materials employed in semiconductor fabrication may be used, examples of which include, but are not limited to silicon dioxide and silicon nitride (SiNx). The protective layer 19 is patterned to expose the second cladding layer 13 for a second electrical contact 16. A layer of photoresist may be applied to the pattern of the protective layer 19. The conductor material may be deposited through known techniques, such as RF sputtering, or DC magnetron sputtering to complete the fabrication of the second electrical contact 16. A second protective layer (not shown) may also be used advantageously in certain embodiments, including those embodiments having an Indium Phosphide (InP) substrate.

With reference to FIG. 3, an optical amplifier 10 is shown wherein angled facets 30, 31 are formed in the optical amplifier 10 and prisms are not used for out-coupling. The optical amplifier 10 is formed with a first angled facet 30 and a second angled facet 31. In preferred embodiments, the first angled facet 30 and the second angled facet 31 are formed by cleaving. Also shown in FIG. 3 are amplified-spontaneous-emission breaks (“ASE-breaks”) 17 that are regions in the active region 11 that have reduced amplification characteristics and that are formed during fabrication of the optical amplifier 10. These ASE-breaks 17 may be present in the active region 11 to prevent or attenuate amplified spontaneous emission in regions of the active region 11 where the electromagnetic field has zero amplitude, which may occur due to the presence of standing waves in the electromagnetic field transverse to the longitudinal axis of the optical amplifier 10. In doing so, the efficiency of the optical amplifier 10 is increased. In FIG. 3, the zigzag structure 18 is defined by interfaces 12a and 13a.

Referring now to FIG. 4, a side view is shown of a signal generator 10 according to an embodiment the present invention. An index-differential layer 21 is shown between the first cladding layer 12 and the substrate 14. As explained in greater detail above, the index-differential layer 21 may facilitate the design process of a particular embodiment of the laser 10 by altering the difference in the refractive index between the zigzag structure 18 and the region outside of the zigzag structure 18, thereby changing the TIR critical angle. As shown, the output beam 1 propagates through a cleaved facet 31. In other embodiments a prism or other suitable optical components may be substituted for facet 31 as an output means. In FIG. 4, the optical resonator 20 is defined by angled facet 31 having a partial reflectivity coating and which acts as a first mirror, and a cleaved end facet 35, which together with a portion of the second cladding/air interface 13a, acts as a roof prism or second mirror. The zigzag structure 18 is defined by faces 12a and 13a. With further reference to FIG. 4, the index-differential layer 21 provides a step in the index of refraction, i.e., an index differential, which may facilitate a desired angle of TIR at the index-differential layer/cladding layer interface. The angles of TIR at this interface may not necessarily be identical to those of the outer cladding layer/air or protective layer interface. If the angles of TIR are not identical, the signal generator 10 behaves somewhat as an asymmetric planar waveguide. The material of the index-differential layer 21 may be a semiconductor or other non-semiconductor material described herein. The semiconductor zigzag laser 10 may include advantageous waveguides (not shown), which are known in the art, to help with lateral confinement of the beam. Such waveguides include, but are not limited to, buried waveguides including covered-mesa buried heterostructures. While the foregoing is true, it is also within the scope of the present invention for the semiconductor zigzag laser to have multiple transverse modes, in which case multiple output channels could be realized for both WDM and TimeDivision-Multiplexing (“TDM”) optical systems.

Minimum values for the refractive index difference between the zigzag structure and the regions outside of it, in particular the index-differential layer, may be calculated by taking into account the available length of the zigzag structure, which length may be dependent on fabrication and construction processes, the desired number of reflections or “bounces” of a beam within the zigzag structure, and the consequent TIR critical angle. The TIR critical angle Oc may be determined from the following equation:

θ_{c}=sin⁻¹ (n₂/n₁); [1]

where n₁ is the index of refraction of the zigzag structure near the boundary, and n₂ is the index of refraction immediately exterior to the zigzag structure. The length of the zigzag structure may be designed by taking into consideration the critical angle Oc in conjunction with the number of bounces that are desired along the zigzag optical axis, and the height of the zigzag structure. θ_{c} defines the critical angle at which the beam will be contained within zigzag structure. In preferred embodiments, the number of bounces is between 4 and 100, and the height of the zigzag structure is on the order of 100 microns.

Referring now to FIGS. 4-6, the active region 11 may also contain one or more mode gain-break regions or ASE-breaks 17. As described previously, these ASE-breaks 17, when present, serve to increase the efficiency of the semiconductor zigzag laser 10 by reducing spontaneous emission in the portions of the active region 11 in which the electromagnetic field has zero amplitude at the desired frequency or frequencies. These ASE-breaks 17 may also serve to prevent or attenuate lasing in a longitudinal mode of the zigzag structure 18 or optical resonator 20. Various techniques known in the art may be used to effect the ASE-breaks 17 in the active region 11. Such techniques include, but are not limited to, etching selected areas of the active region 11, oxidation of selected areas of the active region 11, and proton bombardment of selected areas of the active region 11. Generally, the areas selected to be so treated are strips transverse to the longitudinal or epitaxial or major axis of the active region 11. The ASE-breaks 17 may be advantageously fabricated in other orientations to select modes of operation of the semiconductor zigzag laser 10.

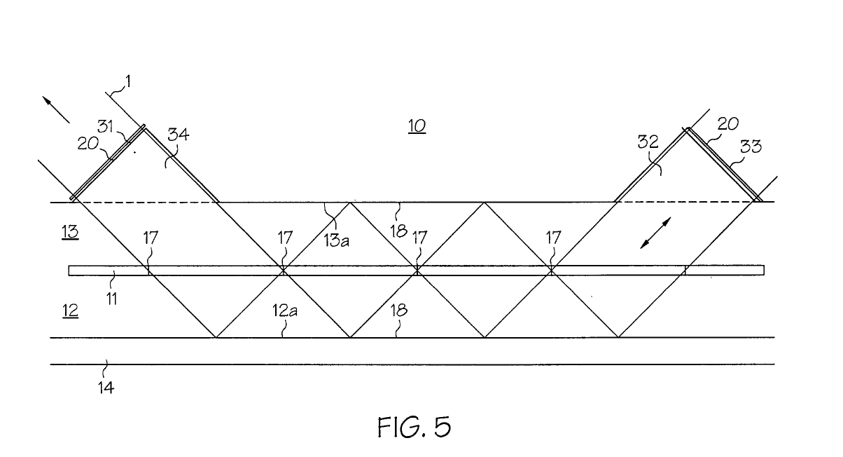

Referring now to FIG. 5, a signal generator 10, similar to that in FIG. 4, is shown with an alternate configuration for optical coupling. A max-reflector 33, which is coupled to a prism 32, is coupled to one end of the signal generator 10 while at the other end, a partial-reflectivity output coupler prism 34 is coupled to the signal generator 10.

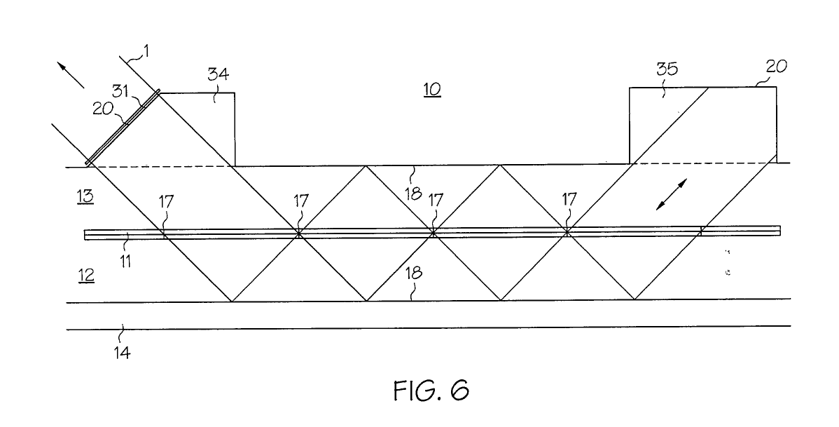

Shown in FIG. 6, is an alternate arrangement for optical coupling of the signal generator 10. A corner-cube prism 35, is shown coupled to one end of the signal generator 10 while at the other end, a partial-reflectivity output coupler prism 34 is coupled to the signal generator 10.

With reference to FIG. 7, a preferred embodiment is shown in which a piezoelectric element 28 is connected to a prism 55 that is placed relatively close, i.e., within a fraction of a wavelength, to the signal generator 10. The piezoelectric element 28 changes shape in response to the applied modulation voltage, thereby coupling the prism 55 to the electric field present in the signal generator 10 through evanescent-wave coupling. This coupling in turn affects how quickly the energy stored within the optical resonator 20 is lost and may be referred to as the quality, Q, of the optical resonator 20. The evanescentwave coupling effectively “shutters” the output beam 1, i.e., modulates the output beam 1 in a binary, on-off manner. In this way, the output beam 1 of the signal generator 10 is modulated, e.g., Q-switched, by the applying the modulation voltage to the piezoelectric element 28. One advantage of this is that for modulating the output beam 1, no optical elements, e.g., Pockels cell, Kerr cell, are needed in the beam path as is shown in FIG. 7, and therefore the modulation of the beam 1 is not hindered by transmission properties of optical elements. As a consequence, beam modulation with the semiconductor zigzag laser may be relatively fast. The piezoelectric element 28, or other modulation means, may be used whether the semiconductor zigzag laser 10 is utilized as a signal generator or as an optical amplifier.

The output beam 1 of the semiconductor zigzag laser 10 can of course be coupled to and modulated by other signal modulators, such as but not limited to, Kerr cells, Pockels cells, and Mach-Zehnder interferometers. Various types of signal modulators, e.g., a Mach-Zehnder interferometer, may be integrated on the same substrate 14 as the semiconductor zigzag laser 10. Reference to “modulation” herein includes the modulation of any characteristic of a light signal, examples of which include amplitude, intensity, polarization, phase, and frequency.

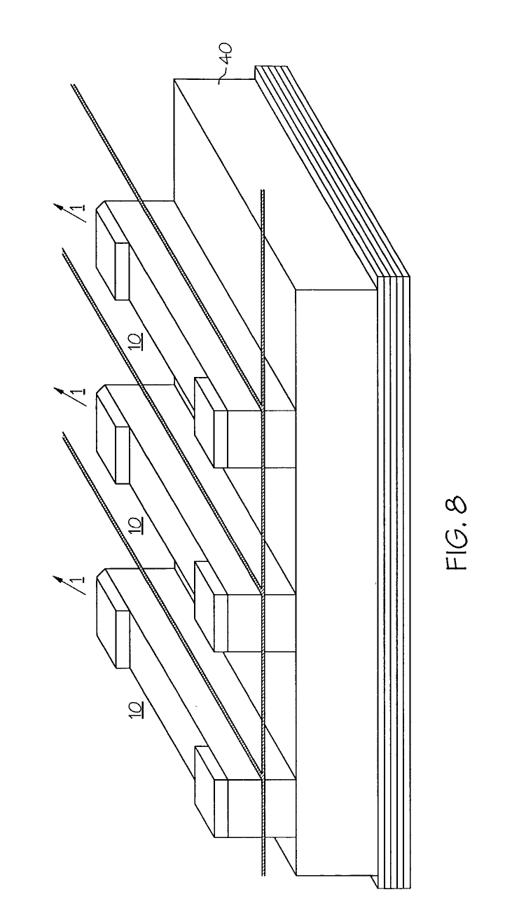

FIG. 8 shows three signal generators 10 mounted on a cooling slab 40, which may be made from copper. This configuration, including the cooling slab 40, effectively dissipates heat built up through operation of the signal generators 10. Other thermal dissipation means known in the art can also be used to effect the heat transfer.

Further embodiments of the present invention include a zigzag structure having multiple active regions. The multiple active regions may be layered parallel to one another and also to the plane of the substrate. When the laser beam reflects at a boundary or TIR surface of the zigzag structure, standing waves may be produced. These standing waves are located at different positions for different wavelengths of light. Multiple active regions can be disposed/fabricated at different heights in the zigzag structure, more specifically, at different distances across the zigzag structure, to efficiently amplify signals of different wavelengths. The multiple active regions may, in preferred embodiments, be each made of different direct-gap semiconductor materials. In this way, various embodiments of the present invention are well suited for use in Wavelength Division Multiplexing (WDM) systems, and Dense Wavelength Division Multiplexing (DWDM) systems, which carry signals having multiple carrier signals, each of a different wavelength, by means of a single optical fiber

Other characteristics of the present invention make it additionally well suited for use in WDM systems. These characteristics include the zigzag beam path within the zigzag structure. Because the index of refraction of an optical material is a function of, among other things, wavelength, photons of different wavelengths have different angles of reflection, and thus different paths within the material. As a consequence, the apparatus according to the present invention may act to disperse light signals of differing wavelength. Consequently, the optical amplifier of the present invention is particularly well suited as a multiplexer or demultiplexer in WDM systems by coupling it to an output prism having multiple output faces or a prism having a diffraction grating formed thereon. Similarly, one or more diffraction gratings may be patterned on an inclined face of the gain region where prisms are not used for optical coupling. The amount of dispersion realized with individual wavelength channels of WDM systems using a optical amplifier, an example of which is described herein, may be chosen by varying the length of the zigzag structure or the dimensions or angles of prisms used for coupling or a combination of both.

A demultiplexer according to an embodiment of the present invention may include an optical input channel, e.g., optical fiber, in optical communication with the zigzag structure and a plurality of optical output channels, e.g., optical fibers, in optical communication with the zigzag structure. A multiplexer according to the present invention may include a plurality optical input channels, e.g., optical fibers, in optical communication with the zigzag structure and an optical output channel, e.g., optical fiber, in optical communication with the zigzag structure. A multiplexer or demultiplexer embodiment of the present invention offer the advantage of being able to amplify the optical signals as the signals are multiplexed or demultiplexed.

Embodiments of the present invention provide the characteristics of high scalability and high integration potential, by a semiconductor zigzag structure design in which the beam size is substantially independent of the height of the lasing medium. Within the zigzag structure, light travels along an optical axis in a saw-tooth or zigzag path. The zigzag path is a result of the difference in the index of refraction between the material(s) of the zigzag structure and the material or region immediately exterior to it. This difference in the index of refraction produces total internal reflection (TIR), and because of this, no complicated or costly feedback structures are necessary. The zigzag structure is in optical communication with one or more inclined facets that allow light to exit or enter the zigzag structure or both enter and exit. When mirrors are placed at opposite ends of the optical axis and outside of the zigzag structure a resonator and consequently a laser is realized. The semiconductor laser and the optical amplifier provide an output beam having a favorable aspect ratio, which enables improved coupling to optical fibers. By the appropriate selection of materials for the active region and appropriate choice of dimensions of the zigzag structure, the semiconductor zigzag laser can be designed to emit photons of a desired optical wavelength.

Within the scope of the present invention, variations on the foregoing can of course be made. For example, the apparatus of the present invention can be scaled to longer lengths to produce higher degrees of gain. In certain embodiments, the active region may be grown directly onto the substrate in which case the substrate itself may be substituted for the first cladding layer. In further embodiments, electric contacts may be placed at different locations on the semiconductor zigzag laser e.g., the ends of the zigzag semiconductor laser. Many locations for the electrical contacts are possible, so long as the positioning of the electrical contacts provides for current flow through the active region.

As another example, the present invention may also serve as a replacement in situations wherein erbium-doped fiber amplifiers are currently used, for example in optical regenerators in long-distance fiber-optic networks.

It will be understood that the foregoing description is by way of example and that it is not limiting on the scope of present invention. Its will further be understood that numerous modifications and variations can be made without departing from the scope of the present invention.

What is claimed is:

1. A semiconductor zigzag optical amplifier comprising:
a zigzag structure having a zigzag optical axis, said zigzag structure in optical communication with a first facet crossing said zigzag optical axis and a second facet crossing said zigzag optical axis, said zigzag structure having a first cladding layer and a second cladding layer;
a first active region disposed between said first cladding layer and said second cladding layer; and
a means for pumping, said means for pumping providing a population inversion in said first active region.

2. The semiconductor zigzag optical amplifier of claim 1, wherein said first cladding layer and said second cladding layer each have an index of refraction greater than a region immediately exterior to said zigzag structure, and wherein an input signal travels in a zigzag path along said zigzag optical axis within said zigzag structure and is amplified by said first active region.

3. The semiconductor zigzag optical amplifier of claim 1, wherein said first facet and said second facet are part of, respectively, a first prism disposed adjacent said first cladding layer and a second prism disposed adjacent said first cladding layer or said second cladding layer.

4. The semiconductor zigzag optical amplifier of claim 1, wherein said first facet and said second facet are each formed across a portion of said first cladding layer or said second cladding layer.

5. The semiconductor zigzag optical amplifier of claim 1, wherein said first facet is part of a first prism disposed adjacent one of said first cladding layer or said second cladding layer and said angled facet is formed across a portion of said first cladding layer or said second cladding layer.

6. The semiconductor zigzag optical amplifier of claim 1, wherein said first active region includes amplified spontaneous emission breaks disposed along the longitudinal axis of said semiconductor active region.

7. The semiconductor zigzag optical amplifier of claim 1, further including a substrate.

8. The semiconductor zigzag optical amplifier of claim 7, wherein said substrate is selected from the group consisting of InP, GaN, and GaAs.

9. The semiconductor zigzag optical amplifier of claim 1, wherein said first active region includes a heterostructure made of a direct-gap semiconductor.

10. The semiconductor zigzag optical amplifier of claim 1, wherein said first active region includes a double heterostructure made of a direct-gap semiconductor.

11. The semiconductor zigzag optical amplifier of claim 1, wherein said first active region includes a quantum well.

12. The semiconductor zigzag optical amplifier of claim 11, wherein said quantum well is made from GaAs and AlGaAs.

13. The semiconductor zigzag optical amplifier of claim 11, wherein said quantum well is made from InP and InGaAsP.

14. The semiconductor zigzag optical amplifier of claim 1, wherein said first active region includes one or more multiple quantum wells.

15. The semiconductor zigzag optical amplifier of claim 14, wherein said one or more multiple quantum wells are made from InP and InGaAsP.

16. The semiconductor zigzag optical amplifier of claim 14, wherein said one or more multiple quantum wells are made from GaAs and AlGaAs.

17. The semiconductor zigzag optical amplifier of claim 14, wherein said one or more multiple quantum wells are doped with a dopant selected from the group consisting of Zn, Be, Mg, and C.

18. The semiconductor zigzag optical amplifier of claim 1, wherein said first active region includes one or more quantum wires.

19. The semiconductor zigzag optical amplifier of claim 1, wherein said first facet and said second facet are parallel to one another with respect to said zigzag optical axis.

20. The semiconductor zigzag optical amplifier of claim 3, wherein said first prism has a plurality of output faces, wherein each of said plurality of output faces is angled to transmit one of a plurality of light signals having different wavelengths.

21. The semiconductor zigzag optical amplifier of claim 3, wherein said first prism has a diffraction grating formed on a surface thereof.

22. The semiconductor zigzag optical amplifier of claim 1, further comprising a second active region disposed within said gain region.

23. The semiconductor zigzag optical amplifier of claim 22, wherein said second active region is parallel to said first active region.

24. The semiconductor zigzag optical amplifier of claim 1, further comprising a plurality of active regions disposed parallel to said first active region.

25. The semiconductor zigzag optical amplifier of claim 24, wherein each of said plurality of active regions is made of a different direct-gap semiconductor.

26. A semiconductor zigzag optical amplifier comprising:
a zigzag structure having a zigzag-optical axis in optical communication with a first facet crossing said zigzag optical axis and a second facet crossing said zigzag optical axis, said zigzag structure having a first cladding layer and a second cladding layer, wherein said zigzag structure has an index of refraction in said first cladding layer and said second cladding layer greater than a region immediately exterior to said zigzag structure;
a first active region disposed between said first cladding layer and said second cladding layer; and
a current source connected to said zigzag structure and operable to provide a pump current to said first active region for providing a population inversion in said first active region.

27. The semiconductor zigzag optical amplifier of claim 26, wherein an input signal travels in a zigzag path within said zigzag structure along said zigzag optical axis and is amplified by said first active region.

28. A semiconductor zigzag laser comprising:
an optical resonator including a zigzag structure having a zigzag optical axis, wherein said zigzag structure is in optical communication with a first facet crossing said zigzag optical axis, said zigzag structure in communication with a second facet crossing said zigzag optical axis, said zigzag structure having a first cladding layer and a second cladding layer, said first facet having a first mirror with a first reflectivity, said second facet having a second mirror with a second reflectivity, wherein said first reflectivity does not equal said second reflectivity, and wherein said first mirror is parallel to said second mirror with respect to said zigzag optical axis;
a first semiconductor active region disposed between said first cladding layer and said second cladding layer; and
a means for pumping, said means for pumping providing a population inversion in said first semiconductor active region.

29. The semiconductor zigzag laser of claim 28, wherein said first cladding layer and said second cladding layer each have an index of refraction greater than a region immediately exterior to said zigzag structure, and wherein an input signal travels in a zigzag path within said zigzag structure and is amplified by said first semiconductor active region.

30. The semiconductor zigzag laser of claim 28, wherein said first facet is provided by a prism disposed adjacent one of said first cladding layer or said second cladding layer.

31. The semiconductor zigzag laser of claim 28, wherein said first facet is formed across a portion of said first cladding layer or said second cladding layer.

32. The semiconductor zigzag laser of claim 28, wherein said first semiconductor active region includes amplified spontaneous emission breaks disposed along a longitudinal axis of said first semiconductor active region.

33. The semiconductor zigzag laser of claim 28, further including a substrate.

34. The semiconductor zigzag laser of claim 33, wherein said substrate is selected from the group consisting of InP and GaAs.

35. The semiconductor zigzag laser of claim 28, wherein said first active region includes a heterostructure made of a direct-gap semiconductor.

36. The semiconductor zigzag laser of claim 28, wherein said first active region includes a double heterostructure made of a direct-gap semiconductor.

37. The semiconductor zigzag laser of claim 28, wherein said first active region includes a quantum well.

38. The semiconductor zigzag laser of claim 37, wherein said quantum well is made from GaAs and AlGaAs.

39. The semiconductor zigzag laser of claim 37, wherein said quantum well is made from InP and InGaAsP.

40. The semiconductor zigzag laser of claim 28, wherein said first active region includes one or more multiple quantum wells.

41. The semiconductor zigzag laser of claim 40, wherein said one or more multiple quantum wells are made from InP and InGaAsP.

42. The semiconductor zigzag laser of claim 40, wherein said one or more multiple quantum wells are made from GaAs and AlGaAs.

43. The semiconductor zigzag laser of claim 40, wherein said one or more multiple quantum wells are doped with a dopant selected from the group consisting of Zn, Be, Mg, and C.

44. The semiconductor zigzag laser of claim 28, wherein said first active region includes one or more quantum wires.

45. The semiconductor zigzag laser of claim 28, wherein said first active region includes one or more quantum dots.

46. The semiconductor zigzag laser of claim 33, wherein said substrate is adjacent said first cladding layer or said second cladding layer.

47. A semiconductor zigzag laser comprising:
an optical resonator including a zigzag structure having a zigzag optical axis, wherein said zigzag structure is in optical communication with a first facet crossing said zigzag optical axis, said zigzag structure in communication with a second facet crossing said zigzag optical axis, said zigzag structure having a first cladding layer and a second cladding layer, said first facet having a first mirror with a first reflectivity, said second facet having a second-mirror with a second reflectivity, wherein said first reflectivity does not equal said second reflectivity, and wherein said first mirror is parallel to said second mirror with respect to said zigzag optical axis;
a first semiconductor active region disposed between said first cladding layer and said second cladding layer; and
a current source connected to said zigzag structure for providing a population inversion in said first semiconductor active region.

48. An optical modulation system comprising:
an optical resonator including a zigzag structure having a zigzag optical axis, wherein said zigzag structure is in optical communication with a first facet crossing said zigzag optical axis, said zigzag structure in communication with a second facet crossing said zigzag optical axis, said zigzag structure having a first cladding layer and a second cladding layer, said first facet having a first mirror with a first reflectivity, said second facet having a second mirror with a second reflectivity, wherein said first reflectivity does not equal said second reflectivity, and wherein said first mirror is parallel to said second mirror with respect to said zigzag optical axis;
a first active region disposed between said first cladding layer and said second cladding layer;
a means for pumping, said means for pumping providing a population inversion in said first active region;
a signal modulator in optical communication with said optical resonator; and
a modulated optical output signal.

49. The optical modulation system of claim 48, wherein said first cladding layer and said second cladding layer each have an index of refraction greater than a region immediately exterior to said zigzag structure, and wherein an input signal travels in a zigzag path within said zigzag structure and is amplified by said first semiconductor active region.

50. The optical modulation system of claim 48, wherein said signal modulator is external to said optical resonator.

51. The optical modulation system of claim 48, said system further including a substrate disposed adjacent said first cladding layer.

52. The optical modulation system of claim 48, wherein said signal modulator includes a piezoelectric element.

53. The optical modulation system of claim 52, wherein said signal modulator further includes a prism disposed adjacent said piezoelectric element.

54. The optical modulation system of claim 48, wherein said signal modulator is selected from the group consisting of a Pockels cell, a Kerr cell, and a Mach-Zehnder interferometer.

55. The optical modulation system of claim 51, wherein said signal modulator is disposed on said substrate.

56. The optical modulation system of claim 55, wherein said signal modulator is a Mach-Zehnder interferometer.

57. An optical modulation system comprising:
an optical resonator including a zigzag structure having a zigzag optical axis, wherein said zigzag structure is in optical communication with a first facet crossing said zigzag optical axis, said zigzag structure in communication with a second facet crossing said zigzag optical axis, said zigzag structure having a first cladding layer and a second cladding layer, said first facet having a first mirror with a first reflectivity adjacent thereto, said second facet having a second mirror with a second reflectivity adjacent thereto, wherein said first reflectivity does not equal said second reflectivity, and wherein said first mirror is parallel to said second mirror with respect to said zigzag optical axis;
a first active region disposed between said first cladding layer and said second cladding layer, wherein an input signal travels in a zigzag path within said zigzag structure and is amplified by said first semiconductor active region;
a current source connected to said zigzag structure and providing a population inversion in said first active region;
a signal modulator in optical communication with said zigzag structure; and
a modulated optical output signal.

58. A method of modulating an optical signal comprising the steps of:
generating a signal from a semiconductor zigzag signal generator; and
modulating said signal with an optical modulator.

59. The method of modulating an optical signal of claim 58, wherein said step of modulating said signal further includes modulating said signal from a state of substantially zero amplitude to a state of maximum amplitude.

60. A semiconductor zigzag demultiplexing system for use in a communication systems that use wavelength division multiplexing, said semiconductor zigzag demultiplexing system comprising:
a zigzag structure having a zigzag optical axis, said zigzag structure in optical communication with a first facet crossing said zigzag optical axis and a second facet crossing said zigzag optical axis, said semiconductor gain region having a first cladding layer and a second cladding layer;
a first semiconductor active region disposed between said first cladding layer and said second cladding layer;
a current source connected to said optical resonator providing a population inversion in said first semiconductor active region;
an input optical fiber in optical communication with said first facet, said optical fiber carrying an input signal including a plurality of separate carrier signals each of a different frequency, wherein each of said plurality of separate carrier signals travels in a separate zigzag path within said gain region and is amplified by said first semiconductor active region; and
a plurality of output optical fibers in optical communication with said second facet, wherein each of said plurality of output optical fibers outputs one of said plurality of separate carrier signals.

61. A semiconductor zigzag multiplexing system for use in a communication systems that use wavelength-division multiplexing, said semiconductor zigzag multiplexing system comprising:
a zigzag structure having a zigzag optical axis, said zigzag structure in optical communication with a first facet crossing said zigzag optical axis and a second facet crossing said zigzag optical axis, said semiconductor gain region having a first cladding layer and a second cladding layer;
a first semiconductor active region disposed between said first cladding layer and said second cladding layer;
a current source connected to said zigzag structure providing a population inversion in said first semiconductor active region;
an plurality of input optical fibers in optical communication with said first facet, each of said plurality of optical fibers operable to carry an input carrier signal of a different frequency, wherein each separate carrier signal travels in a separate zigzag path within said gain region and is amplified by said first semiconductor active region; and
an output optical fiber in optical communication with said second facet, wherein each separate carrier signal so amplified enters into said output optical fiber.

62. A semiconductor laser comprising:
an active region between a first cladding layer and a second cladding layer; and
a first facet and a second facet in optical communication via a zigzag optical axis, wherein the zigzag optical axis passes through the first cladding layer, the active region and the second cladding layer.

63. A semiconductor laser comprising:
at least one active region between a first cladding layer and a second cladding layer; and
a first facet in optical communication with a second facet along a zigzag optical axis, wherein the zigzag optical axis passes through the first cladding layer, the at least one active region, and the second cladding layer.

64. A semiconductor laser comprising:
at least one active region between a first cladding layer and a second cladding layer; and
a first facet in optical communication with a second facet such that when the semiconductor laser is energized a zigzag optical axis is created from the first facet through the at least one active region, to the second facet.
